(19) United States
(12) Patent Application Publication
(10) Pub. No.: US 2009/0285167 A1
(43) Pub. Date: Nov. 19, 2009

(54) SCHEDULED COEXISTENCE

(75) Inventors: Olaf Hirsch, Sunnyvale, CA (US); Parag Garg, Sunnyvale, CA (US); Kumar EswaramoothyY, Santa Clara, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,578

(22) PCT Filed: Jun. 20, 2007
(86) PCT No.: PCT/IB2007/052362

§ 371 Date: Dec. 24, 2008

Related U.S. Application Data
(60) Provisional application No. 60/817,034, filed on Jun. 27, 2006.

(51) Int. Cl. H04W 72/12; H04B 7/00

(52) U.S. Cl. 370/329; 455/41.2

(57) ABSTRACT

The present invention provides a system and a method for improving the wireless local area network (WLAN) throughput performance in a collocated WLAN/Bluetooth system that uses packet traffic arbitration (PTA) to schedule WLAN and Bluetooth transmissions. The method includes detecting a Bluetooth transmission, where the Bluetooth transmission comprises one or more quiet periods; and scheduling a WLAN transmission, where frames of the WLAN transmission are received during the quiet periods of the Bluetooth transmission. The method according to the present invention allows the collocated WLAN to receive a frame send by the access point (AP) and acknowledge its reception without the AP reducing the data transmission rate due to unacknowledged frames. Also, the present invention discloses a mechanism where a collocated Bluetooth device (BTD) and WLAN device can communicate to the AP through a single antenna.

The present invention generally relates to wireless communication, and more specifically relates to scheduling transmissions from collocated Bluetooth device (BTD) and wireless local area network (WLAN) device.

In today's world the use of wireless personal area networks (WPANs) has been gaining popularity because of the flexibility and convenience in connectivity they provide. WPAN systems, such as those based on Bluetooth technology, provides wireless connectivity to peripheral devices and/or mobile terminals by providing short distance wireless links that allow connectivity within a specific distance (10-meter range). In contrast to WPAN systems, Wireless Local Area Networks (WLANs) provide connectivity to devices that are located within a slightly larger geographical area, such as the area covered by a building or a campus, for example. WLAN systems are based on IEEE 802.11 standard specifications, typically operate within a 100-meter range, and are generally utilized to supplement the communication capacity provided by traditional wired local area networks (LANs) installed in the same geographic area as the WLAN system. In some instances, WLAN systems may be operated in conjunction with WPAN systems to provide users with an enhanced overall functionality.

When operating a Bluetooth device (BTD) and a WLAN device in, for example, a wireless device, at two different types of interference effects may occur. One interference effect happens because the Bluetooth devices and WLAN devices transmit on the same or overlapping frequencies.

The second effect occurs if the transceiver of a Bluetooth device is in close proximity to the transceiver of a WLAN device as it is the case in mobile phones or personal digital assistants (PDA). In this instance the transmitter of one device overloads the receiver of the other device and the receiver is not able to receive any signals independent of whether the Bluetooth device and WLAN device use the same frequencies.

An additional problem arises in the increasingly common scenario in which both WLAN and Bluetooth are integrated into the same mobile phone or personal digital assistant (PDA). Collocation interferences arise because of the proximity of the two transceivers. Signals being transmitted from one device cause the other device's receiver to saturate and its receiver becomes desensitized. It becomes a design imperative therefore, to avoid a situation where one system transmits while the other one receives. Another problem occurs if both the systems are transmitting at the same time. Both the devices (Bluetooth device and WLAN device) operate in the same unlicensed ISM band at 2.4 GHz. In this case if both the devices transmit and receive at the same frequency and same time, there are technical challenges in meeting an effective communication. Hence, the transmission has to be scheduled in such a way that both the devices do not transmit at the same time. This is done using packet arbitration (PTA) technique. The PTA algorithm does not allow WLAN to transmit at certain points in time when the Bluetooth needs to receive or transmit. For example, consider a situation when a person is attending a phone call by using a Bluetooth headset and at the same time uploading/downloading emails using the WLAN. The PTA algorithm keeps the WLAN from transmitting at certain points in time when the Bluetooth needs to receive or transmit so that a clear voice is available on the Bluetooth headset.

In the standard communication scenario access points (AP) send frames to the stations (STA) and the STA send an acknowledgement (ACK) upon successful reception of a frame. If PTA is used for WLAN Bluetooth coexistence, Bluetooth can suppress transmissions of the collocated WLAN device. The possible frames that could be suppressed are ACK frames. These frames are sent as a response to a frame from the access point (AP). If the ACK frames are suppressed the access point could wrongly conclude that its frame got corrupted due to a noisy channel or weak signal and retransmit the same frame at a lower data rate. Frames with lower data rate have a higher probability to be corrupted by the collocated Bluetooth making it even more likely that an access point would further reduce its data rate. This ends in a spiral until the access point has reached the lowest data rate. This behavior sternly impacts the throughput of the WLAN system.

Hence, it would be advantageous to provide a method and a system to schedule transmissions from an access point in such a way that scheduling conflicts with the collocated Bluetooth device (BTD) are reduced. The present invention has been developed to meet these needs in the art.

The present invention provides a system and a method for improving the wireless local area network (WLAN) throughput performance in a collocated WLAN/Bluetooth system that uses packet traffic arbitration (PTA) to schedule WLAN and Bluetooth transmissions. The method includes detecting a Bluetooth transmission, where the Bluetooth transmission comprises one or more quiet periods; and scheduling a WLAN transmission, where frames of the WLAN transmission are received during the quiet periods of the Bluetooth transmission. The method according to the present invention allows the collocated WLAN to receive a frame send by the access point (AP) and acknowledge its reception without the AP reducing the data transmission rate due to unacknowledged frames. Also, the present invention discloses a mechanism where a collocated Bluetooth device (BTD) and WLAN device can communicate to the AP through a single antenna via a switch.

In an example embodiment of the present invention, a method for scheduling transmissions from collocated Bluetooth device (BTD) and wireless local area network (WLAN) device is provided. The method includes the steps of detecting a Bluetooth transmission, where the Bluetooth transmission comprises one or more quiet periods; and scheduling a WLAN transmission, where frames of the WLAN transmission are received during the quiet periods of the Bluetooth transmission. Scheduling a WLAN transmission further includes the steps of detecting a type of link of the Bluetooth transmission, sending power save polling (PS-Poll) frames from a WLAN station (STA) to an access point (AP) and requesting pending frames from the AP according to the type of link, and aligning the transmission of PS-Poll frames where the pending frames are received during the quiet periods of Bluetooth transmission.

In another example embodiment of the present invention, a system is provided for scheduling transmissions in wireless communication. The system includes a collocated Bluetooth device (BTD) and a wireless local area network (WLAN) device for enabling wireless communication through Bluetooth transmission and wireless local area network (WLAN) transmission, where the Bluetooth transmission comprises one or more quiet periods; and a wireless local area network (WLAN) station (STA) for scheduling wireless local area network (WLAN) transmission, wherein frames of the WLAN transmission from an access point (AP) are received during the quiet periods of the Bluetooth transmission. The WLAN station (STA) includes a scheduler for scheduling wireless local area network (WLAN) transmission. The scheduler sends power save polling (PS-Poll) frames from the WLAN station (STA) to an access point (AP) and aligns the transmission of the power save polling (PS-Poll) frames in a way that pending frames from the access point (AP) are received during the quiet periods of Bluetooth transmission.

In another example embodiment of the present invention, a system is provided for scheduling transmissions in wireless communication. The system includes a collocated Bluetooth device (BTD) and a wireless local area network (WLAN) device for enabling wireless communication through Bluetooth transmission and WLAN transmission, where the Bluetooth transmission comprises one or more quiet periods; a wireless local area network (WLAN) station (STA) for scheduling wireless local area network (WLAN) transmission, where frames of the WLAN transmission from an access point (AP) are received during the quiet periods of the Bluetooth transmission; and an antenna coupled to said collocated BTD and WLAN device. The WLAN station (STA) includes a scheduler for scheduling WLAN transmission. The scheduler sends PS-Poll frames from the WLAN STA to AP and aligns the transmission of the PS-Poll frames in a way that pending frames from the AP are received during the quiet periods of Bluetooth transmission. The collocated BTD and WLAN device communicates to the AP using a single antenna. This is accomplished by the PS-Poll frame mechanism where the WLAN frames are received during Bluetooth quiet periods. This antenna is triggered to the WLAN mode when WLAN is active and triggered to Bluetooth mode when Bluetooth is active.

The above summary of the present invention is not intended to represent each disclosed embodiment, or every aspect, of the present invention. Other aspects and example embodiments are provided in the figures and the detailed description that follows.

The invention may be more completely understood in consideration of the following detailed description of various embodiments of the invention in connection with the accompanying drawings, in which:

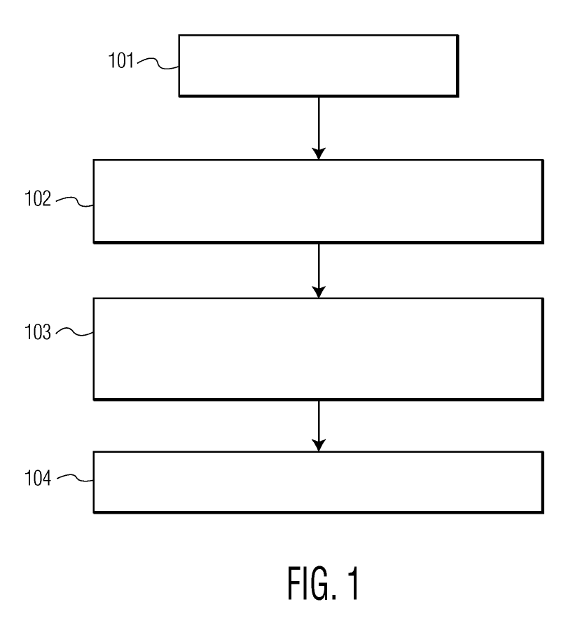

FIG. 1 is a flow diagram illustrating the method of scheduling transmissions from a collocated Bluetooth device (BTD) and WLAN device according to an example embodiment of the present invention.

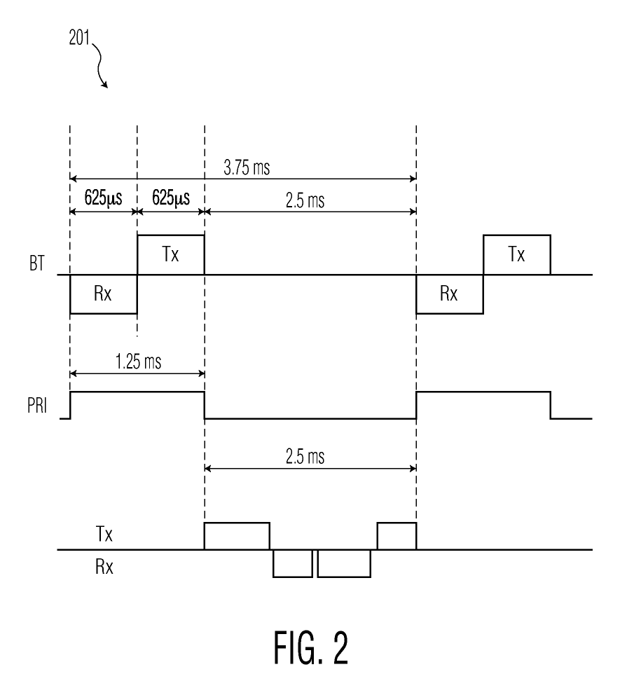

FIG. 2 is a timing diagram that illustrates the method of scheduling transmissions from a collocated Bluetooth device (BTD) and WLAN device according to an example embodiment of the present invention.

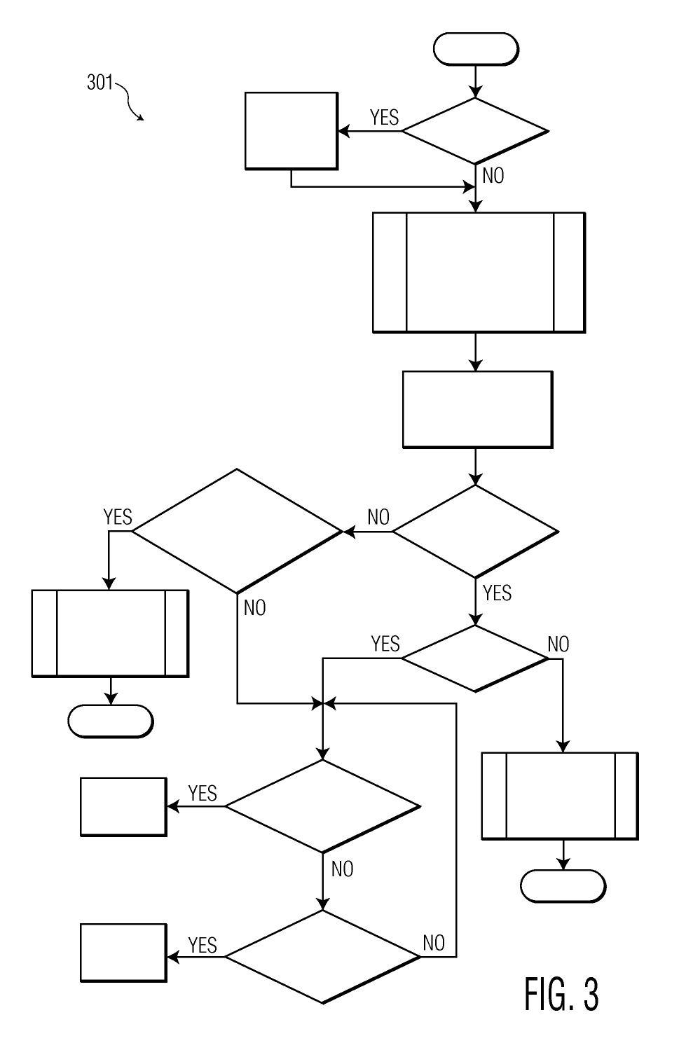

FIG. 3 is a flowchart illustrating the detection of a Bluetooth transmission link.

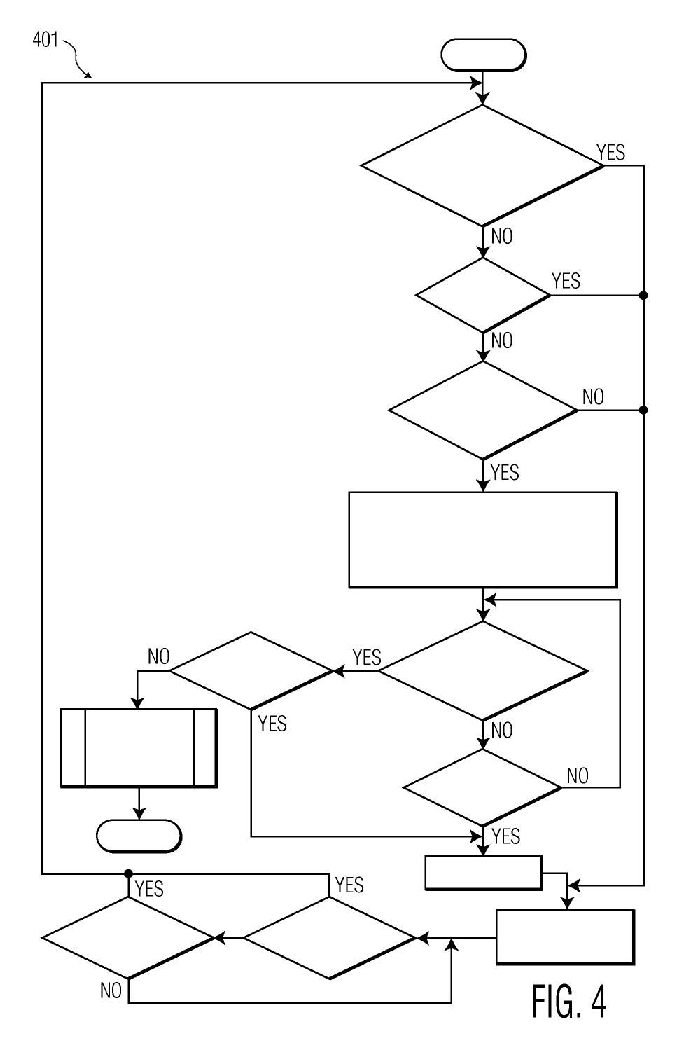

FIG. 4 is a flowchart illustrating the data retrieval method from the access point (AP) if the Bluetooth transmission link detected is a synchronous connection oriented (SCO) link.

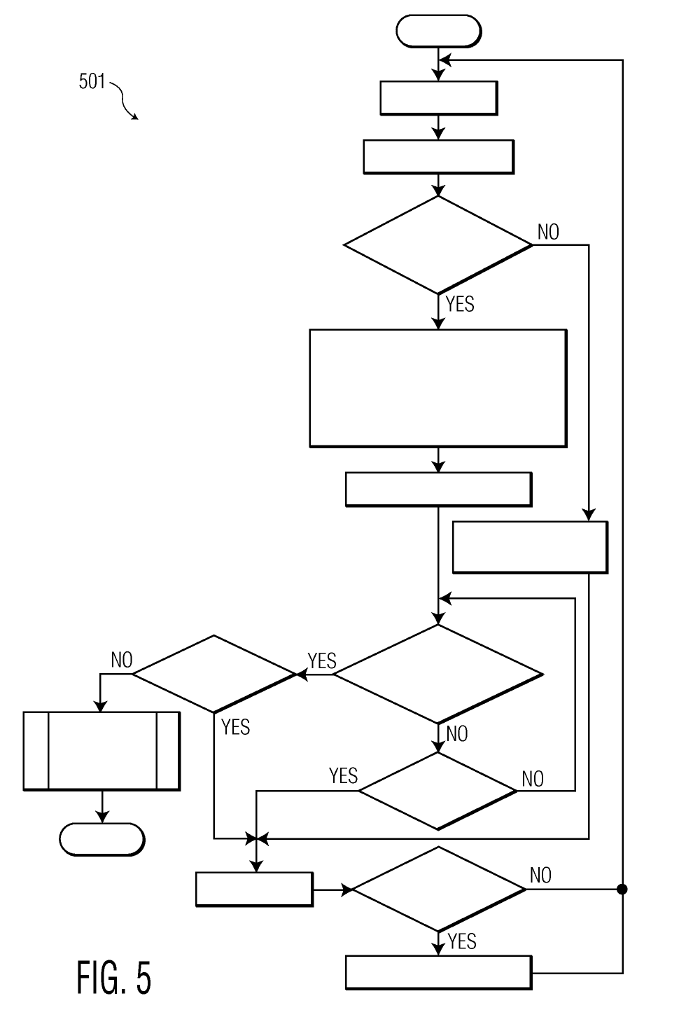

FIG. 5 is a flowchart illustrating the data retrieval method from the access point (AP) if the Bluetooth transmission link detected is an asynchronous connection-less (ACL) link.

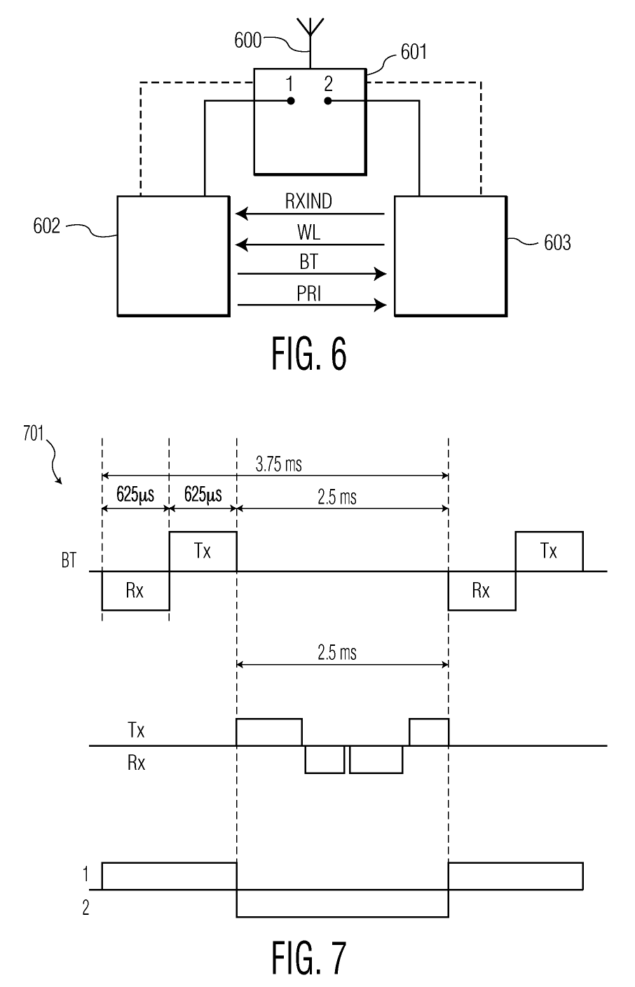

FIG. 6 is a block diagram illustrating the system for single antenna mechanism according to an embodiment of the present invention.

FIG. 7 is a timing diagram that illustrates the method of scheduling transmissions from a collocated Bluetooth device (BTD) and WLAN device through a single antenna.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

FIG. 1 is a flow diagram illustrating the method of scheduling transmissions from a collocated Bluetooth device (BTD) and WLAN device according to an example embodiment of the present invention. The Bluetooth transmission has one or more quiet periods after a cycle of transmission and reception. WLAN transmissions are aligned in such a way that the frames of WLAN transmissions are received during the Bluetooth quiet periods. Before scheduling the WLAN transmissions, the type of link in which Bluetooth is transmitting is detected 101. The different types of Bluetooth transmission links include asynchronous connection-less (ACL) link, synchronous connection oriented (SCO) link and extended synchronous connection oriented (eSCO) link. In the power save mode, WLAN station (STA) sends PS-Poll frames to the access point (AP) and requests for the pending frames from AP 103. Upon successful reception of PS-Poll frames STA receives an acknowledgement (ACK) from the access point. PS-Poll frames are transmitted from STA in such a way that the pending frames from AP are received and acknowledged when the Bluetooth is not active (quiet period) 102. STA sends an ACK frame upon successful reception of pending frames from AP 104. The scheduling according to the present invention maximizes the probability that the collocated WLAN receives the frame and acknowledges the reception with an ACK frame. This reduces the number of suppressed ACK frames and also reduces the probability of AP lowering the transmission data rate. Since AP transmits frames at a higher data rate, the probability that these frames are corrupted by a Bluetooth transmission is also reduced.

The PS-Poll frames are scheduled to minimize the frames that the collocated WLAN is not able to acknowledge. There are some frames that are corrupted due to other reasons than Bluetooth. These corrupted frames trigger the AP to lower its data transmission rate starting the spiral down to lower rates. Once the lowest data transmission rate is reached, the AP will not regain the higher data rates.

The rate recovery mechanism is a way to make the AP restart with the higher data rates. The rate recovery mechanism is explained as follows. The WLAN station (STA) detects unicast frames with low data transmission rates which are transmitted from the access point (AP). If a certain number (which is programmable) of such unicast frames are received, WLAN STA transmits a de-authentication frame to the AP. Due to the de-authentication frame, AP discards the information about the WLAN STA (e.g. data transmission rate about the WLAN STA). Following to sending the de-authentication frame, the WLAN STA resends an authentication frame and the AP restarts at the highest data rate.

FIG. 2 is a timing diagram that illustrates the method of scheduling transmissions from a collocated Bluetooth device (BTD) and WLAN device according to an example embodiment of the present invention 201. When the Bluetooth is in a voice link, there is transmission and reception for a period of 625 μs each following by a quiet period of 2.5 ms where there is no activity. This is one Bluetooth cycle. The total time taken for a complete Bluetooth cycle including the quiet period is 3.75 ms. Bluetooth cycles continuously repeat in this manner.

WLAN station (STA) transmits a PS-Poll frame to the access point (AP). AP responds to the PS-Poll frame by sending an ACK frame back to the WLAN station followed by the transmission of pending frames. Upon receiving the pending frames, WLAN station acknowledges the reception by sending an ACK frame to the AP. The STA signals to the BTD that it is reserving the medium. Where the STA requests multiple pending frames from the AP, it acknowledges each reception with an ACK frame. The number of requested frames is programmable. In one embodiment, the STA requests frames during a predetermined amount of time, which can be programmable. In another embodiment, the BTD signals to the STA that it is reserving the medium. The BTD can reserve the medium for multiple frames, where the number of frames can be programmable. In one embodiment, the BTD can reserve the medium up to a predetermined amount of time, which can be programmable.

The scheduling of PS-Poll frames sent by the WLAN station makes sure that the pending frames from the AP are received and acknowledged during the quiet period of Bluetooth transmission (2.5 ms). If the STA is not in power save mode, AP will transmit pending frames at any time and if the frames fall in the time when Bluetooth is transmitting, there is a higher probability that the frames get destroyed. Also, when the frames are received early enough by the WLAN station, but if the Bluetooth is receiving in the next cycle, WLAN station cannot transmit the ACK frame successfully to the access point.

There are different signal lines between the Bluetooth device (BTD) and WLAN device. One among those signals is a priority line (PRI) which indicates important Bluetooth packets according to their priority status. When the PRI lines goes low (as illustrated in FIG. 2), PS-Poll frames are sent from the WLAN station. Scheduling behavior of PS-Poll frames varies according to the type of Bluetooth links (SCO and ACL links). So, STA has to detect the type of link Bluetooth is currently executing. Link detection is explained under the description of the FIG. 3.

FIG. 3 is a flowchart illustrating the detection of a Bluetooth transmission link 301. Due to the different behavior for SCO and ACL links the STA has to detect the type of link Bluetooth is currently executing. The link detection is done each time the STA wakes up to receive a beacon or after it has received a beacon while it was awake. The detection process relies on the toggling PRI line. After receiving a beacon, PRI interrupt is enabled. PRI timer is started for 4 ms. If a beacon is not received, STA checks for data received in previous beacon period, and if not so, STA releases WL line and enters sleep. If data was received a PS-Poll frame will be scheduled. If a beacon is received, STA checks whether any PRI interrupt was received and, if so, SCO mode is selected.

If PRI interrupt is not received and if the PRI timer has expired, ACL mode is selected. There is the possibility of false detection of Bluetooth links because Bluetooth uses the PRI line also at other instances than during a SCO link (E.g. failed access during ACL data transmission, inquiry/paging (scan), scatternet, etc). False detection should only cause reduced throughput for the duration of one beacon period but not lead into a spiral that will cause the AP to lower the data transmission rate.

FIG. 4 is a flowchart illustrating the data retrieval method from the access point (AP) if the Bluetooth transmission link detected is a synchronous connection oriented (SCO) link 401. If a SCO link is detected, only one PS-Poll is sent out per Bluetooth voice frame. Additional checks are made to make sure that a PS-Poll is sent out only if enough time is available to acknowledge the response frame. If PS-Poll frames are sent by another station in the previous 3 ms, PRI timer is set to 2.5 ms. If there are no PS-Poll frames sent by another station, and if network allocation vector (NAV) is not set, STA checks whether transmit queue is empty. If transmit queue is empty, WLAN station transmits PS-Poll frames with backoff set to 1, and sets WL line. In case of no response from AP, a time out timer is set for 2.5 ms. WL line is set as close to the falling PRI edge as possible to make sure that the medium acquired is from Bluetooth.

When response frames are received from AP, STA checks for the requirement of sending more PS-Poll frames. If the more flag is not set, STA releases WL and enters sleep. If the more flag is set, PRI timer is set to 2.5 ms. STA is not able to detect when the collocated Bluetooth device (BTD) is a master and transmits a Poll frame. The Bluetooth Poll frame is transmitted during the 2.5 ms when SCO link is not scheduling any information. If a PS-Poll frame is scheduled during a Bluetooth Poll frame the AP rate adaptation algorithm can be triggered. It is therefore advisable to increase the Bluetooth poll interval to at least 80 ms.

FIG. 5 is a flowchart illustrating the data retrieval method from the access point (AP) if the Bluetooth transmission link detected is an asynchronous connection-less (ACL) link 501. During an ACL link, PS-Poll frames are scheduled in such that Bluetooth has the possibility to access the medium without using priority access. WLAN station sets WL line and waits for BT=0 and transmit queue to be empty. If transmit queue is empty, WLAN station sends PS-Poll frames with backoff set to random value and also sets WL line. In case of no response from AP, a time out timer is set for 2.5 ms. After sending PS-Poll frames, BT line detection is started. BT line activity indicates that Bluetooth is active and might transmit data. When response frames are received from AP, STA checks for the requirement of sending more PS-Poll frames. If more flags are not set, STA releases WL and enters sleep. If more flags are set, WL line is released. If a BT edge is detected, WL line is set for WL=0 for a period of 2 ms.

The regular Bluetooth poll frame can disturb the reception WLAN reception. It is therefore advisable that the Bluetooth polling period is increased to at least 80 ms or more. Scatternets also make use of additional PRI accesses. These accesses have the potential to disrupt the PS-Poll algorithm and can cause the AP to lower its data rate. Bluetooth parameters should be set in such that priority access is minimized.

FIG. 6 is a block diagram illustrating the system for single antenna mechanism according to an embodiment of the present invention. The collocated BTD 602 and WLAN device 603 is coupled to an antenna 600. By using the PS-Poll mechanism, the WLAN frames are received during Bluetooth quiet periods. In this scenario, both WLAN device 603 and BTD 602 are able to share a single antenna 600 for transmissions. Each time when WLAN device sends out a PS-Poll frame (when BTD does not require the medium) the antenna is set to the WLAN mode. By using the aforementioned mechanism the BTD 602 and WLAN device 603 uses a single antenna for communicating with the AP.

In an alternative embodiment, an antenna switch mechanism is disclosed as described below.

An antenna switch 601 is coupled to the antenna 600 as shown in FIG. 6. The antenna switch 601 can be triggered either from BTD 602 or WLAN device 603 by sending triggering frames according to the respective transmissions. The antenna switch position 1 is coupled to the BTD 602 and position 2 is coupled to the WLAN device 603. When the antenna switch 601 is in position 2, BTD 602 is not able to transmit or receive and when in position 1, WLAN device 603 is not able to transmit and receive.

In this embodiment, by the PS-Poll frame mechanism as described under the description of FIG. 1, the WLAN device 603 is transmitting only during the Bluetooth quiet periods and BTD 602 is transmitting only when the WLAN device 603 is not receiving any pending frames from AP. In this configuration if the WLAN device 603 is sending PS-Poll frames to the AP, the antenna switch is triggered to position 2, and the WLAN device 603 sends the PS-Poll frames and receives the pending frames from AP. After the WLAN device 603 acknowledges the reception of pending frames the antenna switch 601 is released to position 1 for Bluetooth transmissions.

FIG. 7 is a timing diagram that illustrates the method of scheduling transmissions from a collocated Bluetooth device (BTD) and WLAN device through a single antenna 701. The antenna switch is set to position 1 when Bluetooth is active (for a time period of 1.25 ms). After 1.25 ms the antenna switch is triggered to position 2 when WLAN device sends PS-Poll frames to the AP. The WLAN device receives ACK and pending frames from the AP and acknowledges the reception by an ACK frame (for a time period of 2.5 ms). After the WLAN transmission, the antenna switch is released to position 1 for Bluetooth transmissions.

The applications of the present invention includes, but not limited to, WPAN devices such as mobile phones or personal digital assistants (PDAs) that use Bluetooth and WLAN in a close proximity.

While the present invention has been described with reference to several particular example embodiments, those skilled in the art will recognize that many changes may be made thereto without departing from the spirit and scope of the present invention, which is set forth in the following claims.

1. A method for scheduling transmissions from collocated Bluetooth device (BTD) and wireless local area network (WLAN) device, comprising the steps of:
detecting a Bluetooth transmission, wherein said Bluetooth transmission comprises one or more quiet periods; and
scheduling a wireless local area network (WLAN) transmission, wherein frames of the WLAN transmission are received during said quiet periods of the Bluetooth transmission.

2. The method of claim 1, wherein said scheduling a wireless local area network (WLAN) transmission further comprising the steps of:
detecting a type of link of the Bluetooth transmission;
sending power save polling (PS-Poll) frames from wireless local area network (WLAN) station (STA) to an access point (AP) and requesting pending frames from said access point (AP) according to said type of link; and
aligning the transmission of said power save polling (PS-Poll) frames wherein said pending frames are received during the quiet periods of Bluetooth transmission.

3. The method of claim 2, wherein said sending power save polling (PS-Poll) frames includes sending according to a type of link detected from the Bluetooth transmission, said type of link includes asynchronous connection-less (ACL) link, synchronous connection oriented (SCO) link and extended synchronous connection oriented (eSCO) link.

4. The method of claim 2, wherein power save polling (PS-Poll) frames are not send from said wireless local area network (WLAN) station (STA) to the access point (AP) if a network allocation vector (NAV), pending frame and power save polling (PS-Poll) frames from another WLAN station (STA) are send.

5. The method of claim 1, wherein said scheduling power save polling (PS-Poll) frames if the type of link is asynchronous connection-less (ACL) link comprises scheduling power save polling (PS-Poll) frames such that during said asynchronous connection-less (ACL) link, Bluetooth has the accessibility to the medium without using priority access.

6. The method of claim 1, wherein scheduling power save polling (PS-Poll) frames if the type of link is synchronous connection oriented (SCO) link comprises sending one power save polling (PS-Poll) frames per a Bluetooth voice frame.
(I removed this because I don't think it is relevant for the scheduling part)

7. The method of claim 1, wherein scheduling power save polling (PS-Poll) frames if the type of link is enhanced synchronous connection oriented (eSCO) link comprises sending one power save polling (PS-Poll) frames per a Bluetooth voice frame.

8. The method of claim 1, wherein the WLAN station (STA) receives pending frames from the access point (AP) and acknowledges the reception with an acknowledgement (ACK) frame, whereby data transmission rate is not reduced by the access point (AP).

9. The method of claim 1, wherein the WLAN station (STA) receives pending frames from the access point (AP) and acknowledges the reception with an acknowledgement (ACK) frame, whereby WLAN station (STA) signals to the Bluetooth device (BTD) that it is reserving the medium.

10. The method of claim 9, wherein the WLAN station (STA) request multiple pending frames from the access point (AP) and acknowledges each reception with an acknowledgement (ACK) frame.

11. The method of claim 10, wherein the number of requested frames is programmable.

12. The method of claim 9, wherein the WLAN station (STA) requests frames during a predetermined amount of time.

13. The method of claim 12, wherein the predetermined amount of time is programmable.

14. The method of claim 1, wherein the Bluetooth device (BTD) signals to the WLAN station (WLAN) that it is reserving the medium.

15. The method of claim 1, wherein the Bluetooth device (BTD) can reserve the medium for multiple frames.

16. The method of claim 15, wherein the number of frames is programmable.

17. The method of claim 1, wherein the Bluetooth device (BTD) can reserve the medium up to a predetermined amount of time.

18. The method of claim 17, wherein the predetermined amount of time is programmable.

19. The method of claim 8, wherein the WLAN station (STA) transmits said acknowledgement (ACK) frame to the access point (AP) even in case of a cyclic redundancy check (CRC) error detected in the received frames.

20. The method of claim 1, the WLAN station (STA) resets the access point's (AP) data transmission rate comprising the steps of: detecting low data rate unicast frames from the access point (AP); sending a de-authentication frame from the WLAN station (STA) to the access point (AP); and resending an authentication frame from the WLAN station (STA) to the access point (AP).

21. The method of claim 10, wherein said sending a de-authentication frame, whereby the WLAN station (STA) resets the access point (AP) data transmission rate.

22. The method of claim 1, wherein the number of power save polling (PS-Poll) frames send during the quiet periods are made dependent on duration of quiet periods and wireless local area network (WLAN) data transmission rate.

23. The method of claim 1, wherein power save polling (PS-Poll) frames are transmitted if a beacon is not received and if data is received in a previous beacon period.

24. A system for scheduling transmissions in wireless communication, said system comprising:
a collocated Bluetooth device (BTD) and a wireless local area network (WLAN) device for enabling said wireless communication through Bluetooth transmission and wireless local area network (WLAN) transmission, wherein said Bluetooth(BT) transmission comprises one or more quiet periods; and
a wireless local area network (WLAN) station (STA) for scheduling said wireless local area network (WLAN) transmission, wherein frames of the WLAN transmission from an access point (AP) are received during said quiet periods of the Bluetooth transmission.

25. The system as in claim 14, wherein said WLAN station (STA) comprises a scheduler for scheduling wireless local area network (WLAN) transmission, said scheduling further comprises of sending power save polling (PS-Poll) frames from a WLAN station (STA) to an access point (AP) and aligning the transmission of said power save polling (PS-Poll) frames wherein pending frames from the access point (AP) are received during the quiet periods of Bluetooth transmission.

26. The system as in claim 15, wherein said scheduler further comprises a means of detecting a type of link of the Bluetooth transmission.

27. The system as in claim 15, wherein scheduling power save polling (PS-Poll) frames if the type of link is asynchronous connection-less (ACL) link comprises scheduling power save polling (PS-Poll) frames such that during said asynchronous connection-less (ACL) link, Bluetooth has the accessibility to the medium without using priority access.

28. The system as in claim 15, wherein scheduling power save polling (PS-Poll) frames if the type of link is synchronous connection oriented (SCO) link comprises sending one power save polling (PS-Poll) frames per a Bluetooth voice frame and transmitting a Bluetooth polling frame during the period when said synchronous connection oriented (SCO) link is not scheduling any information.

29. The system as in claim 15, wherein scheduling power save polling (PS-Poll) frames if the type of link is enhanced synchronous connection oriented (eSCO) link comprises sending one power save polling (PS-Poll) frames per a Bluetooth voice frame and transmitting a Bluetooth polling frame during the period when said enhanced synchronous connection oriented (eSCO) link is not scheduling any information.

30. The system as in claim 14, wherein said WLAN station (STA) receives frames from the access point (AP) and acknowledges the reception with an acknowledgement (ACK) frame, whereby data transmission rate is not reduced by the access point (AP).

31. A system for scheduling transmissions in wireless communication, said system comprising:
a collocated Bluetooth device (BTD) and a wireless local area network (WLAN) device for enabling said wireless communication through Bluetooth transmission and wireless local area network (WLAN) transmission, wherein said Bluetooth(BT) transmission comprises one or more quiet periods;
a wireless local area network (WLAN) station (STA) for scheduling said wireless local area network (WLAN) transmission, wherein frames of the WLAN transmission from an access point (AP) are received during said quiet periods of the Bluetooth transmission; and
an antenna coupled to said collocated Bluetooth device (BTD) and said wireless local area network (WLAN) device.

32. The system as in claim 21, wherein said WLAN station (STA) comprises a scheduler for scheduling wireless local area network (WLAN) transmission, said scheduling further comprises of sending power save polling (PS-Poll) frames from a WLAN station (STA) to an access point (AP) and aligning the transmission of said power save polling (PS-Poll) frames wherein pending frames from the access point (AP) are received during the quiet periods of Bluetooth transmission.

33. The system as in claim 21, wherein said antenna is triggered to a wireless local area network (WLAN) mode when wireless local area network (WLAN) is active; and the antenna is triggered to a Bluetooth mode when the Bluetooth is active.

34. The system as in claim 21, wherein the antenna is controlled by the WLAN station (STA).

35. The system as in claim 21, wherein the antenna is controlled by the collocated Bluetooth device (BTD).

36. The system as in claim 21, wherein the antenna is controlled by the collocated Bluetooth device (BTD) and the WLAN station (STA).
